(19) United States
(12) Patent Application Publication
(10) Pub. No.: US 2012/0021162 A1
(43) Pub. Date: Jan. 26, 2012

(54) PANEL STRUCTURE MADE OF WOODEN MATERIAL AND PROCESS FOR OBTAINING SUCH PANELS

(76) Inventor: Siro Martin, Pordenone (IT)

(21) Appl. No.: 13/138,374

(22) PCT Filed: Sep. 24, 2009
(86) PCT No.: PCT/IB2009/007000

§ 371 Date: Aug. 8, 2011

(30) Foreign Application Priority Data
Feb. 11, 2009 (IT) PN2009A000013

(51) Int. Cl. A47B 96/20; B23P 17/04; B32B 3/14

(52) U.S. Cl. 428/77; 29/530

(57) ABSTRACT

Structure of panels made of wooden material for manufacturing furniture items, furniture components, related ornamental fittings, and the like, and products of various kind, wherein the sides of the panels are joined to each other by an outer covering and an inner covering and/or further sides and/or stiffening members and/or inserts, thereby delimiting a hollow zone at the angular joining regions, wherein such hollow zone is then filled with filler material or inserts and a manufacturing method for such panel structures.

The present invention refers to a structure of panels made of wooden material and a process for obtaining such panel structure.

In the furniture-making industry of these days, the various furniture pieces, such as cabinets, cupboards and the like, furniture components, related ornamental or complementary items, etc., are made up starting from a set of panels that are appropriately joined with each other by means of fixed or restrained joints of various kinds, and then caused to blend into each other and coated or clad, wherein such blending of the panels into each other generally occurs via appropriately rounded corners, and such panels may also be obtained with the aid of other manufacturing techniques, such as for example the so-called rounded folding technique, consisting in the fact of first of all providing an elongated strip of wooden material having the same length as two contiguous or consecutive sides of each panel, or all of the sides of the same panel, and having the same height and the same thickness as such panel, and then applying and attaching on to the outer surface of two contiguous or consecutive sides or all of the sides of each panel a covering sheet of wooden material (the so-called “inlay”) having the desired aesthetical and decorative appearance, and then shaping the butt edges of the mutually contiguous sides to such a contour as to ensure that, when these sides are bent orthogonally relative to each other and brought close to each other along the respective butt edges, in the condition in which also the covering sheet is bent orthogonally, between these butt edges there is defined a hollow zone; thereupon, the opposite butt edges of these sides are joined to the opposing butt edges of the remaining sides of the panel, thereby defining a hollow zone also in this case, and finally into all thus created hollow zones there is filled a plastic filler material, such as for instance polyurethane foam, or there are fitted appropriate pre-fabricated inserts of plastic material having a complementary contour, so that such hollow zones are filled with this materials and are in this way joined to each other with materials generally known as such in the art.

A further method being prevailingly used in manufacturing panels blending into each other in a continuous manner on the outer and/or inner surface thereof, consists of the step of traditionally pressing—by means of a die and related counter-die—curved pieces, or sections, made of a multiplicity of layers of a thin and flexible wooden material, which are bonded together by gluing. This method implies a necessity for a die and related counter-die or matrix of a specially designed kind to be used, which shall furthermore be arranged so as to be able to make use of the high-frequency technique in view of accelerating the time needed to cause the glue—used in a considerable amount in the application—to dry up, i.e. a condition in which such drying process is carried out under an unavoidable environmental pollution effect, a high energy usage and long dwelling times in the die of the pieces, proportionately to the actual thickness of the panels to be obtained, and—as a result—under quite considerable overall production costs.

It therefore is a main object of the present invention to provide, with a simple production process, which differs from the above-noted ones and does not share any of the above-cited drawbacks, a structure of panels of wooden material for furniture in general, furniture components, shelves, consoles and the like, the joining corners of which are blended and possibly radiused in the manner that shall be described in greater detail further on, while also obtaining reinforced joints such as to strengthen the entire resulting structure.

This structure of panels of wooden material and the related process for producing the same are provided by incorporating the construction features and characteristics as substantially described with particular reference to the appended claims.

The present invention will anyway be more readily understood from the description that is given below by way of non-limiting example with reference to the accompanying drawings, in which:

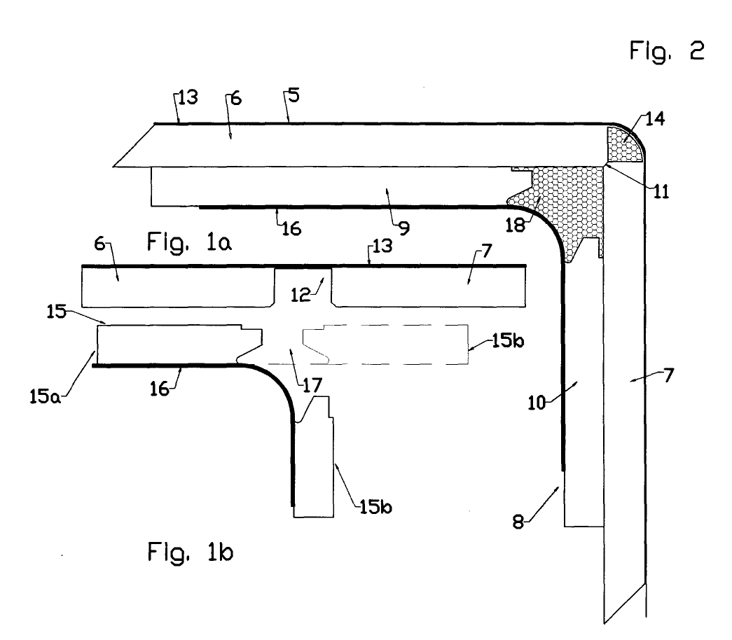

FIGS. 1a and 1b are plan views of a first embodiment of the structure of a panel of wooden material according to the present invention, as viewed in two different stages of the manufacturing process;

FIG. 2 is a plan view of the structure of a complete panel made as illustrated in FIGS. 1a and 1b;

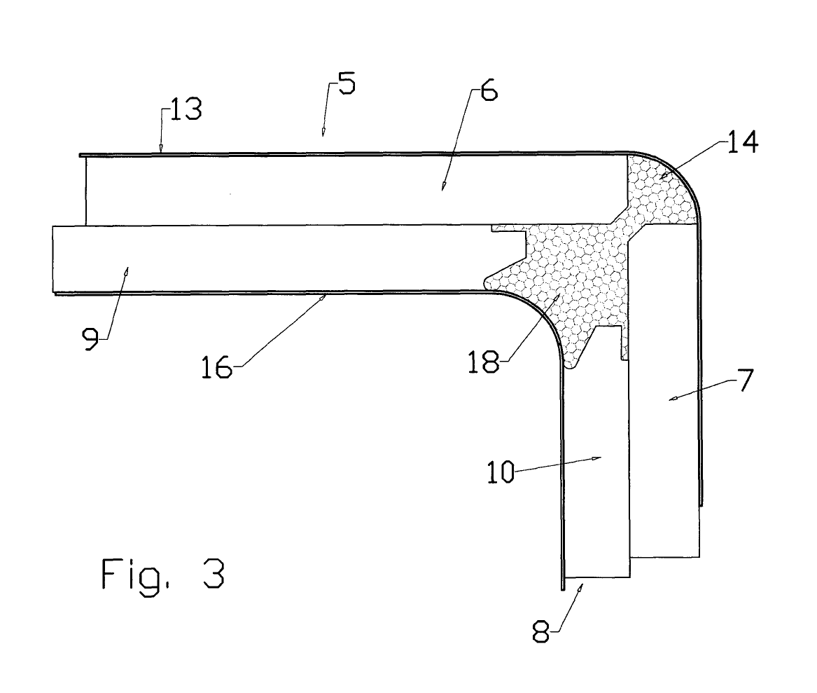

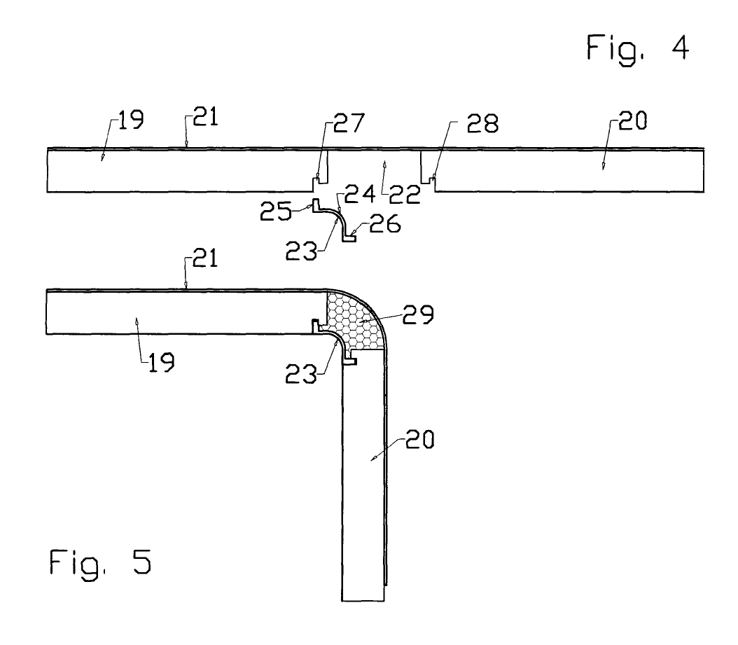

FIG. 3 is a plan view of a modified embodiment of the panel shown in FIG. 2;

FIG. 4 is a plan view of the various component parts, as viewed during the assembly of a second embodiment of a panel structure according to the present invention;

FIG. 5 is a plan view of the structure of a complete panel made up of the component parts shown in FIG. 4;

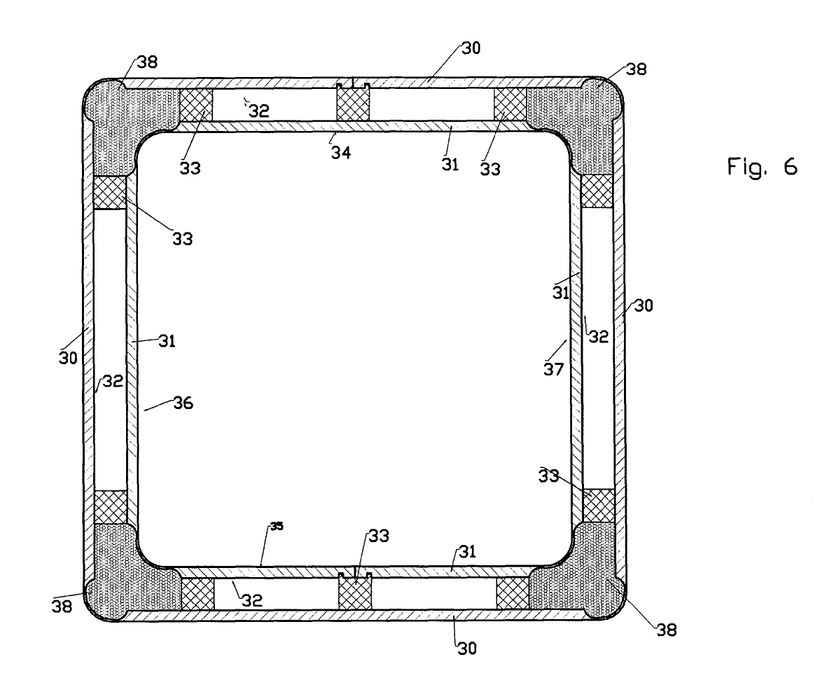

FIG. 6 is a plan view of a third embodiment of a panel structure according to the present invention;

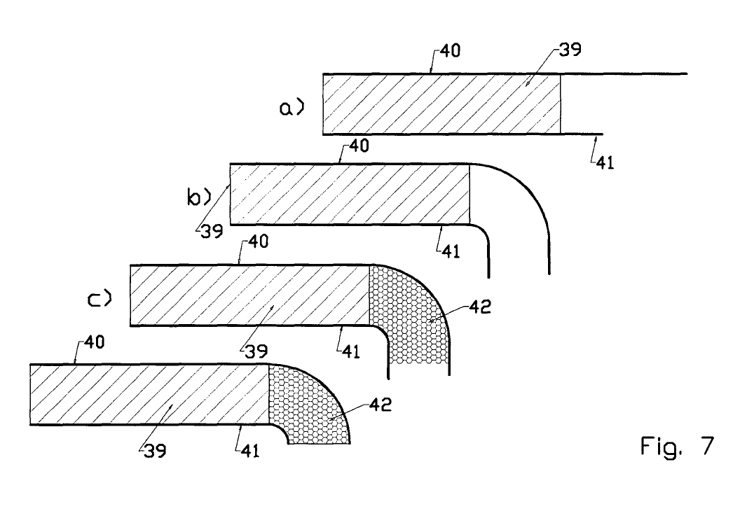

FIG. 7a, b, c are plan views of the different manufacturing steps of a process for making a panel structure according to the present invention, in a fourth embodiment thereof;

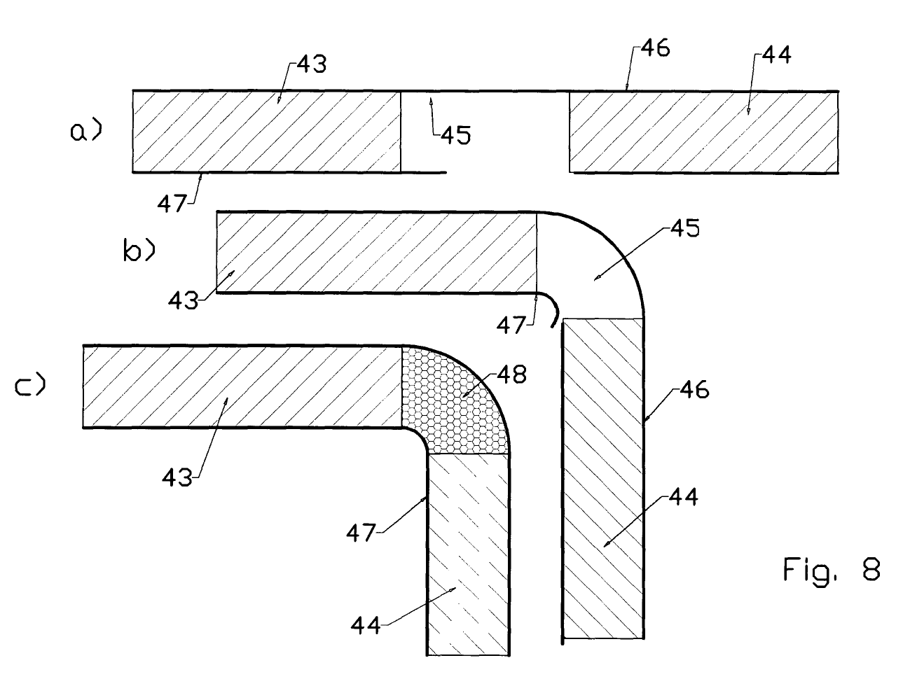

FIG. 8a, b, c are plan views of the different manufacturing steps of a process for making the structure of the panel illustrated in FIG. 7, in modified embodiment thereof;

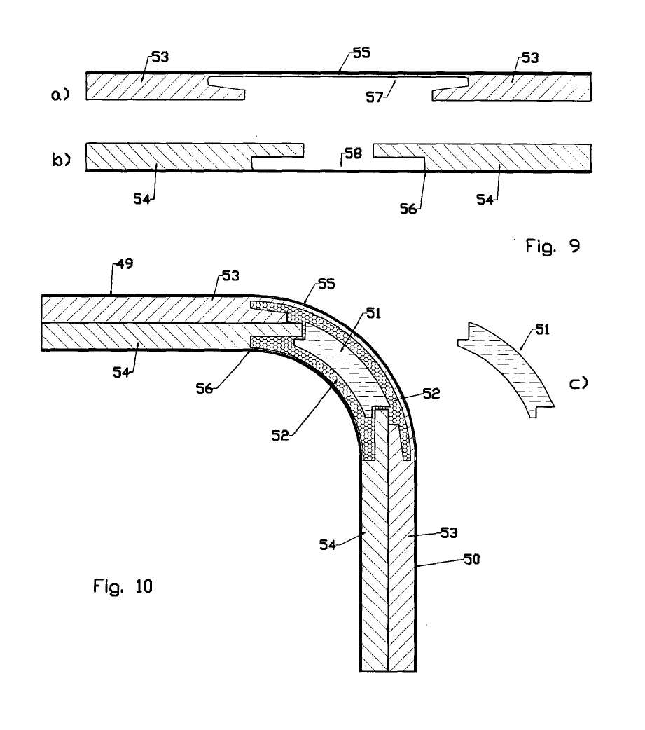

FIG. 9a, b, c are plan views of the different component parts of a panel structure according to the present invention, in a fifth embodiment thereof;

FIG. 10 is a plan view of the structure of a complete panel made up of the component parts shown in FIG. 9;

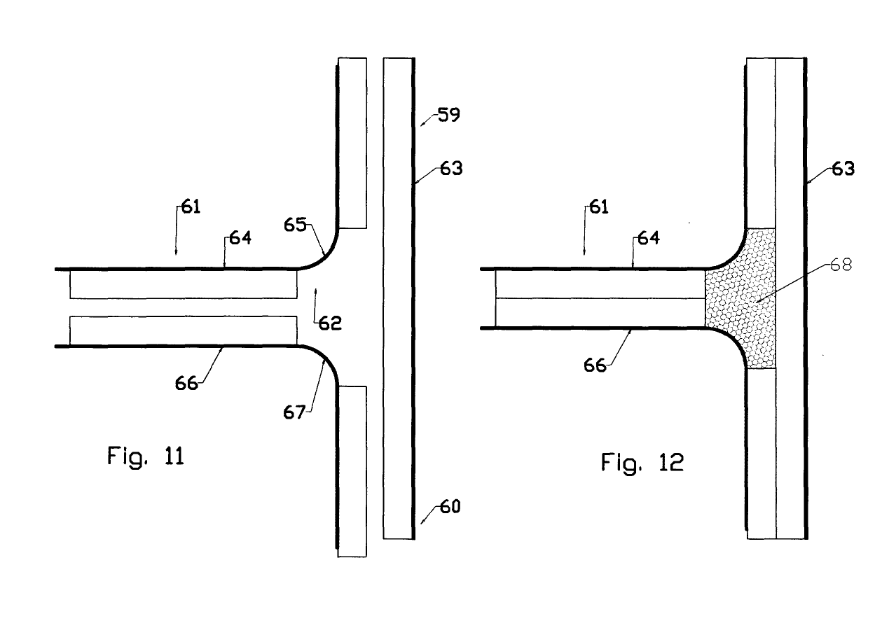

FIG. 11 is a plan view of a sixth embodiment of the present invention, consisting of a set of three panels that are being assembled together;

FIG. 12 is a plan view of the complete structure of panels resulting from the assembly of the panels illustrated in FIG. 11;

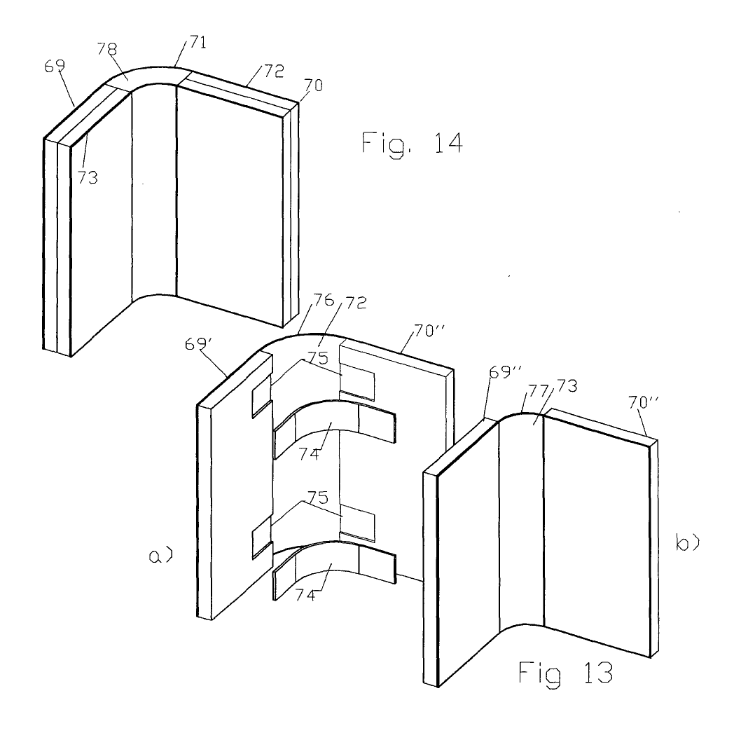

FIG. 13a, b are front perspective views of the component parts of a seventh embodiment of a panel structure according to the present invention, as viewed in a state in which they are being assembled together;

FIG. 14 is a front perspective view of the panel structure resulting from the assembly of the component parts illustrated in FIG. 13;

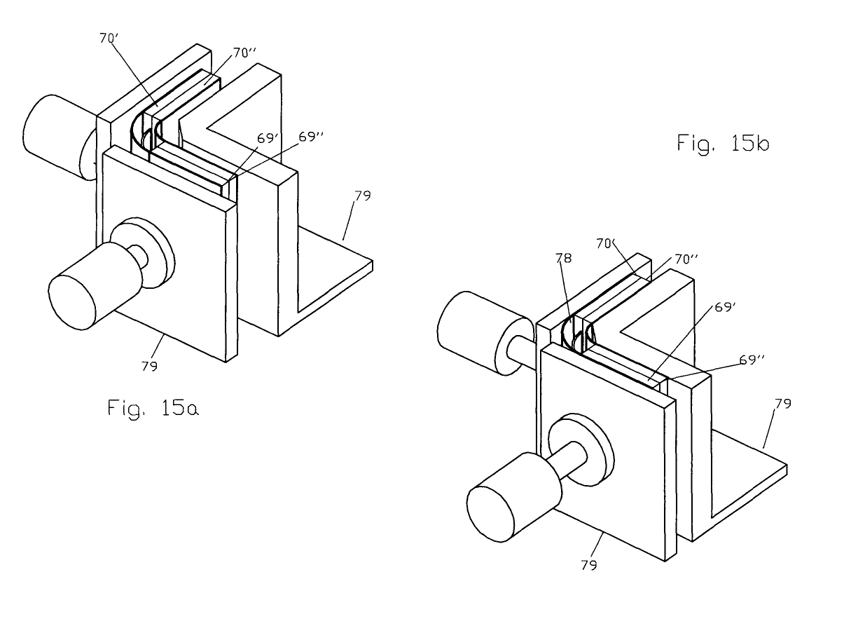

FIG. 15a, b are front perspective views of the assembly steps, and an assembly tool, of the component parts of the panel structure shown in FIG. 14;

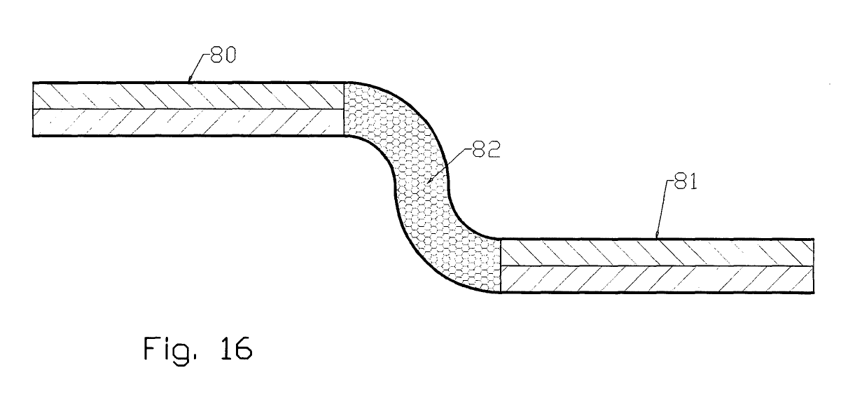

FIG. 16 is a plan view of an eighth embodiment of a panel structure according to the present invention;

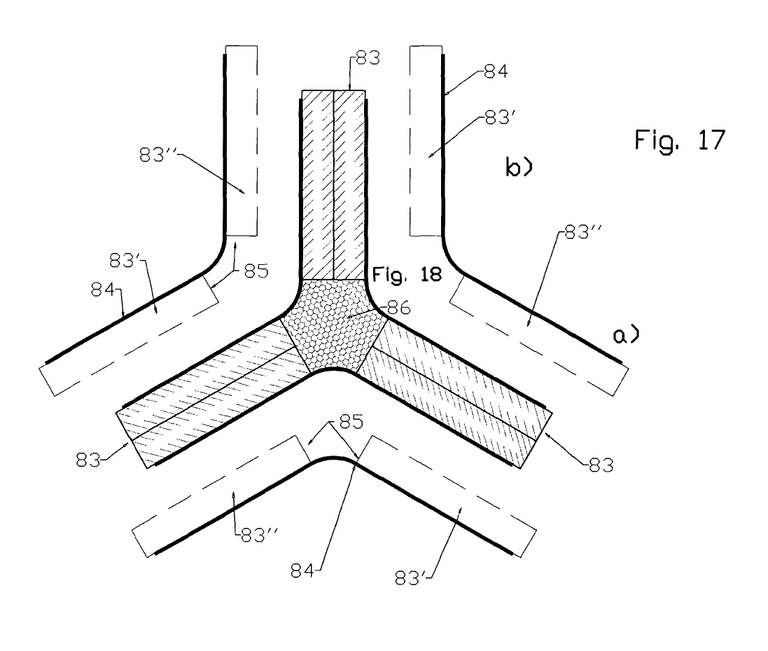

FIG. 17a, b are plan views of the component parts of a ninth embodiment of a panel structure according to the present invention, as viewed in a state in which they are being assembled together;

FIG. 18 is a plan view of the panel structure resulting from the assembly of the component parts illustrated in FIG. 17;

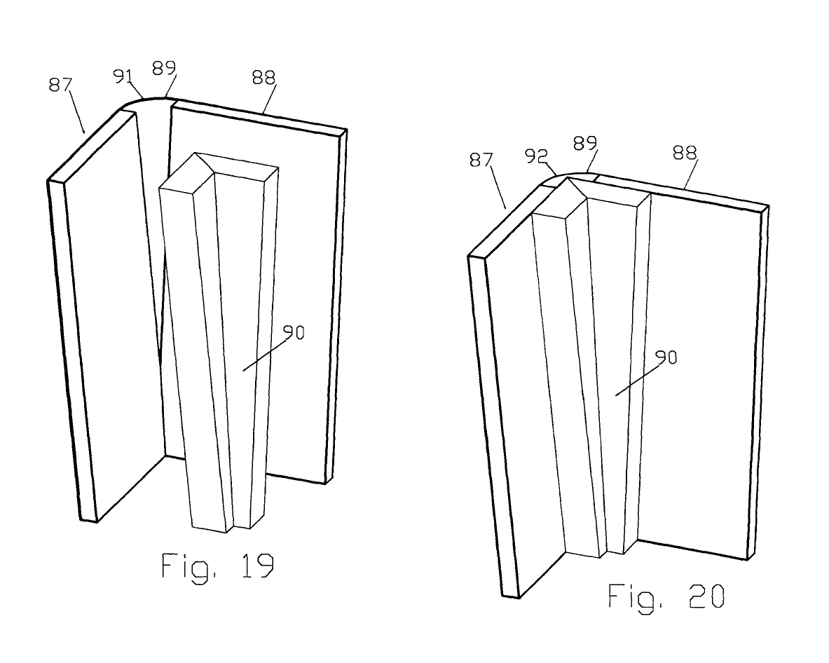

FIG. 19 is a front perspective view of the component parts of a panel structure according to the present invention, in a tenth embodiment thereof;

FIG. 20 is a front perspective view of the panel structure resulting from the assembly of the component parts illustrated in FIG. 19;

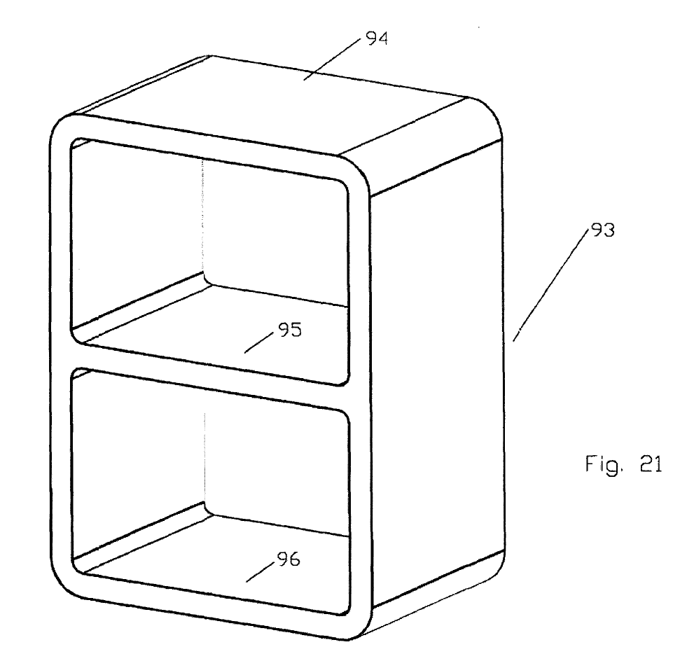

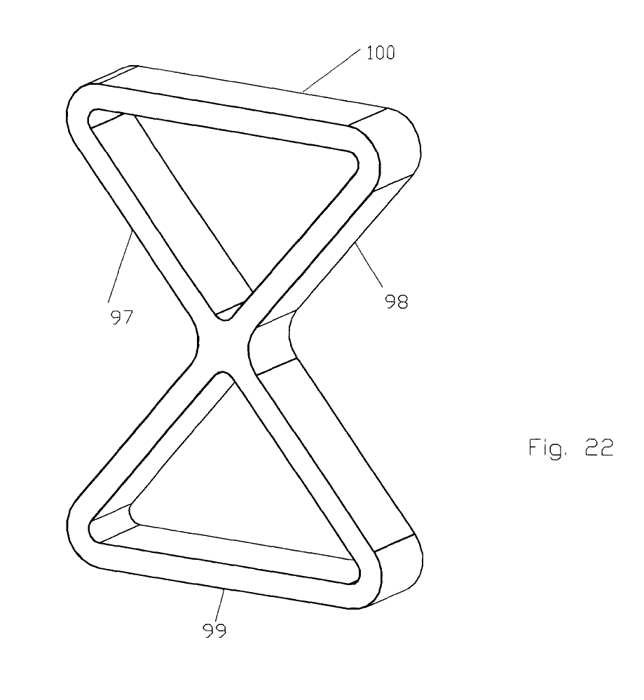

FIG. 21 is a front perspective view of a panel structure according to the present invention, in an eleventh embodiment thereof;

FIG. 22 is a front perspective view of a panel structure according to the present invention, in a twelfth embodiment thereof.

Illustrated schematically in the above-listed Figures is a structure of panels made of wooden material, along with a related manufacturing process for making the same structure, according to the present invention, wherein such panels are adapted for use in the furniture-making industry for the production of furniture equipment and outfit in general, furniture component parts, ornamental additions thereof, and the like, or even other products of various kind, some exemplary embodiments of such structure of panels being in particular illustrated to illustrative purposes.

With reference to FIG. 2, there is shown a first embodiment of such structure of panels according to the present invention, which, in the particular example considered, is comprised of a first panel 5 including two rectilinear sides 6 and 7, which are adjacent to each other, and bent orthogonally relative to each other, and a second panel 8, which also includes two rectilinear sides 9 and 10 lying are adjacent to each other and bent orthogonally relative to each other, which are placed in contact with and glued, i.e. bonded against the inner portion of the corresponding sides 6 and 7 of the first panel 5.

At the joining zone thereof, the sides 6 and 7 of the first panel 5 are connected to each other via a short section 11 that is defined by carving or anyway providing an appropriately shaped front clear, i.e. hollow zone 12 in the same sides. On the outer portion of each thus carved and contoured side 6 and 7 there is first of all applied and attached, by means of gluing or bonding, at least a sheet of covering wooden material 13 (i.e. the so-called “inlay”) having the desired aesthetic appearance, which may be solely applied in the joining zone of these two sides, but can of course be applied all over the length of each side, as this can be seen in FIG. 1a, so that such sides—as bent orthogonally relative to each other—turn out as being joined to each other both by the section 11 and the covering sheet 13. Next, in the front hollow zone 12 there is introduced a filler material 15 of suitable plastics, such as for example polyurethane foam, or there is introduced an insert of the same material as the panel, or even other materials that may be judged as being suitable for the application, in such a way that said insert is able to perfectly fit into said hollow zone and fill it completely, wherein all these operations are carried out with the use of traditional tools and working methods, thereby bringing about a stable, firm and rigid connection of the two sides 6 and 7 to each other in a bent arrangement in which they extend orthogonal relative to each other. In turn, the second panel 8 is prepared through the processing steps illustrated in FIGS. 1a and 1b, in the first one of which (see FIG. 1a) there is formed an elongated rectilinear strip 15, and there is used a sheet of covering material 16 having a rectilinear shape, which may also be of a wooden material, but can be made of a material of any other suitable kind, which is intended for cooperating with said elongated strip, as this shall be described further below, and in the median region of said elongated strip 15 there is provided an appropriately shaped hollow zone 17 which, in the example shown in this Figure, is obtained by cutting the elongated strip so as to obtain two strip portions 15a and 15b spaced, i.e. separate from each other, but which may of course be provided even in any other way that keeps the contiguous ends of such strip portions joined to each other. In the following steps (see FIG. 1b), on the inner side of one of said strip portions, i.e. the strip portion 15a in the example shown in the Figure, there is applied and attached by gluing a portion of the sheet of covering material 16 which, owing to its being flexible, is appropriately bent, whereas the other bent portion of such sheet of covering material 16 is applied and attached by gluing onto the inner side of the other strip portion 15b, thereby bringing about a connection of the two above-mentioned strip portions. In this way, the two strip portions 15a, 15b form the two rectilinear sides 9 and 10 of the second panel 8, which are then bent by a same bending angle as the corresponding sides 6 and 7 of the first panel 5; in this case, they are bent orthogonally relative to each other and the outer portion of each side 9 and 10 is then arranged in contact and glued relative to the opposite side 6 and 7 of the first panel 5, and in this condition the second panel 8 turns out as being fixed indissolubly in the rear part of the first panel 5, as this can be seen in FIG. 2, whereas the covering sheet 16 turns out as being bent in a curving manner in the joining zone between the two sides 9 and 10, thereby delimiting the hollow zone 17 obtained in the afore-described manner, and in this hollow zone there is finally introduced a filler medium 18 of plastic material, such as for instance polyurethane foam, or there is fitted an insert of the same material, or even of some other material suitable for the application, in such a way that said insert is able to perfectly fit into said hollow zone and fill it completely, wherein also all these operations are carried out with the use of traditional tools and working methods, thereby bringing about a stable, firm and rigid connection of the two sides 9 and 10 both to each other and against the corresponding sides of the first panel 5. Owing to the two above-described outer and inner covering sheets 13 and 16 being so used concurrently along with a second panel 8 attached on the back side—not exposed to view—of the first panel 5, the possibility is in this way created for structures of panels, or even products of some other kind, to be provided in different con formations thereof, or even products of some other kind, by only making use of universal-type jigs for the assembly of the panels, or said other products, as the case may be, under cold processing conditions, i.e. by means of processes carried out at room temperature, and in reduced processing times, without any use of specially designed dies and related bottom-dies, as this has been up to now necessary with the prevailing processing method in use. Moreover, the panels, or said other products of various kind, obtained in this way have frequently a lighter weight as compared with the panels, or products, that can be obtained with the use of the current production techniques, since use is made in this case of filler materials or inserts made of materials that are generally lighter, and such panels, or products, also feature an improved dimensional/angular stability and additionally enable panels to be obtained, which are joined to, i.e. blend with each other via curved portions, with variable and progressive curvature angles, thanks to the presence of the curved and flexible covering sheets in the joining zones where the various panels blend into each other. Further advantages of this manufacturing method for structures of panels or products will be described further on, wherein some further possible embodiments of the present invention shall be illustrated and described first by way of non-limiting example aimed at a better understanding thereof.

Shown in FIG. 3 is the above-described embodiment of a panel structure according to the present invention in a modified construction thereof, in which use is again made of two panels 5 and 8 that are made and attached to each other in the above-described manner, while they have in this case different sizes as compared with the afore-cited panels, however. The filler materials or inserts 14 and 18 used in this case for the panels 5 and 8, respectively, are in the same shape as the afore-described ones and, as compared with the afore-described ones, are communicating with each other in this case. Illustrated in FIG. 5 is a second exemplary embodiment of the structure of panels according to the present invention, in which there can be noticed that the sides of the panel 19 and 20 are fully covered, on the outwards facing surface thereof, by a covering sheet 21, as duly glued on to such front surface, and these sides 19 and 20 are fully cut off, i.e. severed from each other along the adjacent butt-edges thereof, thereby defining a hollow joining zone 22 even in this case, whereas the inner portions of the same sides are covered by a short extruded profile section 23 of a wooden, plastic or similar material, which is again glued on to such sides and is formed of a middle curved portion 24 blending into two short rectilinear legs 25 and 26 at the sides, which fit into and are glued on to corresponding grooves 27 and 28 provided in the inner surface of the related panel sides, so that the hollow joining zone 22 is in this way delimited between the covering sheet 21 and the profile section 23 to be then filled with filler material or an insert 29 in the usual manner. Best to be seen in FIG. 4 is the way in which said panel sides 19 and 20 are assembled together, wherein said panel sides are first brought into mutual alignment, slightly spaced from each other, so as to define the hollow joining zone 22 between the symmetrical butt-edges thereof. Then, the covering sheet 21 is glued on to the outwards facing surface of said sides, while the profile section 23 is applied on to the inner surface of the same sides by first fitting and gluing one of the rectilinear legs (i.e. the leg 25 in the example considered) of the profile section into the corresponding groove 27 of the side 19, and then bending the other side 20 orthogonally relative to the first side 19 to finally fit and glue the other leg 26 into the corresponding groove 28 of the panel side 20 and fill the hollow zone 22 with the filler material or the insert 29.

Shown in FIG. 6 there is a third exemplary embodiment of the panel structure according to the present invention, which is in the shape of a square in this case, as constituted by rectilinear sides extending parallel to and spaced from each other, these sides being covered by an outer covering layer and an inner covering layer as usual, and being joined to each other by means of filler materials or inserts at their corners.

This panel structure is comprised of four pairs of outer and inner sides 30 and 31, which are slightly spaced from each other to thereby define an inner hollow chamber 32 between them, in which there are introduced and attached related inserts 33. In the above-mentioned Figure there can be noticed a first pair 34 of inner and outer sides, a second pair 35 of inner and outer sides extending parallel to and spaced from the first pair 34, a third pair 36 of inner and outer sides extending orthogonally relative to said first and second pairs 34 and 35, and a fourth pair 37 of inner and outer sides extending parallel to and spaced from the third pair 36. All outer sides 30 and inner sides 31 of the various pairs of sides also act as covering materials, i.e. covering layers, and are made thinner, i.e. reduced in the thickness thereof, at the corner regions thereof to define in this way related hollow zones that are due to be filled with corresponding filler materials or inserts 38. In this manner, the sides of the panel structure are provided in a narrower thickness, under definitely smaller material usage, and are lighter in weight as compared with the panel sides completely full of filling material typical of prior-art solutions. In addition, they ensure full mechanical strength thanks to the provision of reinforcement inserts 33 as indicated above.

A fourth exemplary embodiment of the panel structure according to the present invention is shown in FIG. 7. In particular, FIG. 7a can be noticed to illustrate both a rectilinear panel side 39 having a given length and the manner in which the same is manufactured. In the same Figure there can be noticed that, on the outer and inner surfaces of said side 39 there is applied and glued a respective covering sheet 40, 41, which differ in length from each other, wherein the outer covering sheet 40 is namely longer than the inner one 41, so that, when the ends of the covering sheets are bent orthogonally, they fall into perfect alignment with each other (see FIG. 7b), thereby defining the hollow zone due to be filled with filler material 42 (see FIG. 7c), in such manner that said covering sheets 40 and 41 are able to slightly protrude outwards with their end portions, which are then either folded down or joined to corresponding covering sheets of an adjacent side (not shown), as the case may be.

Shown in FIG. 8 is the above-described embodiment of a panel structure according to the present invention, as illustrated in FIG. 7, in a modified construction thereof In this case, the panel itself is made up by two rectilinear sides 43 and 44 (see FIG. 8a), which are first brought into mutual alignment, slightly spaced from each other, so as to thereby delimit the hollow joining zone 45. Then, the covering sheet 46 is applied and glued on to the outwards facing surface of both said sides 43 and 44, wherein such covering sheet 46 is therefore effective in keeping the same sides joined together, whereas the other covering sheet 47 is shorter than the sheet cited above and is applied and glued on to the inner surface of a single side, i.e. the side 43 in this example, so that the free end of this sheet 47 is able to extend and penetrate into the hollow zone 45 by such an extent as to ensure that, when the side 44 is bent orthogonally relative to the other side 43 (see FIG. 8b), jointly with the related covering sheets 46 and 47, the extension of the inner covering sheet 47 is curved and reaches up to the inner surface of the same side 44 to ultimately be able to be in this way glued into position, and that the hollow zone 45 is again delimited by both said inner curved covering sheet 47 and the outer curved covering sheet 46, as in all other cases, to be then filled with a filler material or an insert 48 (see FIG. 8c), thereby joining both sides 43 and 44 firmly together.

FIG. 10 illustrates a fifth exemplary embodiment of the panel structure according to the present invention, in which there can be noticed two sides 49 and 50 as bent orthogonally relative to each other and joined together again with the use of filler materials or inserts 51 and 52, wherein these sides are comprised of two rectilinear side portions 53 and 54 that are glued to each other in the longitudinal direction of the same side, said side portions 53 and 54 being coated with a covering sheet, i.e. the first one with an outer covering sheet 55 on the outwards facing surface thereof, and the second one with an inner covering sheet 56 on the inwards facing surface thereof.

Illustrated in FIG. 9 are the component parts of this panel structure, which include a first elongated side portion 53 (see FIG. 9a), a second elongated side portion 54 (see FIG. 9b), and a pre-fabricated insert 51 (see FIG. 9c) adapted to be fitted into the joining zone between the sides 49 and 50. The assembly of these component parts is carried out by placing the side portions 53 and 54 in a mutually juxtaposed, i.e. side-by-side arrangement, and hollowing out the same side portions in the zone at which the sides 49 and 50 join together, thereby creating respective hollow zones 57 and 58 that are so shaped and contoured as to be able to subdivide each side portion into two side half-portions spaced from each other. Then, such side portions 53 and 54 are first glued to each other in the longitudinal direction thereof, and then bent orthogonally to each other, thereby forming the sides 49 and 50 as they are shown in FIG. 10, while in the hollow zone being delimited between the butt edges of these sides there is fitted the insert 51, thereby delimiting, between said insert and the outer curved covering sheet 55 and the inner curved covering sheet 56, a cavity that is eventually filled with the filler material or the insert 52.

Shown in FIGS. 11 and 12 there is a sixth exemplary embodiment of the panel structure according to the present invention, which is in this case made up by three sides formed of three panels joined to each other, i.e. a first and a second rectilinear panel 59 and 60 provided in an aligned arrangement relative to each other, and a third rectilinear panel 61 joined in an orthogonal arrangement to said first and second rectilinear panels 59 and 60 in the median region thereof, wherein each side is comprised of two side half-portions glued in the longitudinal direction of the same side, and in the median region of the panels there is provided a hollow zone 62 (see FIG. 11). Even in this case, on the panels there are first applied and glued the covering sheets, and in particular on the outwards facing surfaces of the first and the second panel 59 and 60 there is applied and glued the covering sheet 63 having a rectilinear extension, whereas on one of the inwards facing surfaces of the third panel 61 there is applied and glued a covering sheet 64 that extends from said third panel up to the first panel 59, into which it blends via a curvature 65. Then, the middle hollow zone 62 is filled with the filler material or the insert 68 (see FIG. 12), thereby firmly and rigidly connecting the three sides together and obtaining the desired panel structure in its finished state.

Shown in FIG. 14 there is a seventh exemplary embodiment of the panel structure according to the present invention, which is comprised of two rectilinear sides 69 and 70 in an orthogonal arrangement relative to each other and joined to each other via a curvature 71, each one of such sides being formed of two side half-portions glued together in the longitudinal direction of the respective side, and is coated as usual with an outer covering sheet 72 and an inner covering sheet 73.

As can be seen in FIG. 13, in which there are shown the various component parts of such panel structure, it can be noticed that these are comprised of the two side half-portions 69′ and 70′ joined to each other by the outer covering sheet 72, and narrow inserts 74 having an elongated shape (see FIG. 13a), which are shorter than said side half-portions 69′ and 70′ and are bent, as duly radiused, orthogonally relative to each other, said inserts being adapted to be fitted into corresponding recesses 75, which are provided in said side half-portions, and glued therein so as to firmly join said half-portions to each other; such component parts further comprise the two side half-portions 69″ and 70″ joined to each other by the inner covering sheet 73 (see FIG. 13b) and capable of being adapted against the formerly cited side half-portions, thereby defining a curved hollow zone just where the curvatures 76 and 77 of the outer covering sheet 72 and the inner covering sheet 73 lie. Shown in FIG. 14 is the panel structure obtained by bringing the two side half-portions 69′ and 70′ and the two side half-portions 69″ and 70″ close together, alongside each other, and filling the middle curved hollow zone with the filler material or the insert 78.

FIGS. 15a and 15b illustrate the process of assembling together the various component parts of the panel structure shown in FIG. 14, which is done by first of all joining the side half-portions 69′ and 70′ and the side half-portions 69″ and 70″ close together in a juxtaposed arrangement, and clamping them tightly together by means of an appropriate pressing tool 79 of a traditional kind (see FIG. 15a), and then pouring the filler material or fitting the insert 78 into the middle hollow zone created therebetween by such side half-portions in the clamped state thereof (see FIG. 15b).

Illustrated in FIG. 16 there is an eighth exemplary embodiment of a panel structure according to the present invention, which is also in this case comprised of two rectilinear sides 80 and 81 made up by two side half-portions glued to each other in the longitudinal direction, wherein such sides are not aligned with each other in this case, but are rather offset, i.e. staggered relative to each other, and are joined together via a twofold bent, i.e. radiused connection of a filler material or an insert 82, and this joint is made and brought about using the same manufacturing criteria and principles described above.

FIG. 18 can be noticed to illustrate a ninth exemplary embodiment of a panel structure according to the present invention, which is this time in a star shape with three identical sides 83 angularly spaced from each other, each one of which is formed of a related, equally long side half-portion 83′ covered by the related covering sheet 84 (see FIG. 17a), and a related, equally long side half-portion 83″, extending at an angle and joining with the corresponding side half-portion 83′ by way of the same covering sheet 84 (see FIG. 1 7b), so as to define a hollow zone 85 between said side half-portions 83′ and 83″. This structure of panel is obtained by bringing all side half-portions 83′ and 83″ close together and filling all resulting hollow zones 85 with the filler material or an insert 86.

Illustrated in FIGS. 19 and 20 there is a tenth exemplary embodiment of a panel structure according to the present invention, which is shown to be formed into a configuration including two rectilinear sides 87 and 88 arranged orthogonally to each other and tapering downwards into a conical shape, which join to each other via a curvature 89 and are connected with each other by means of an inner, complementarily shaped insert 90, which also performs as an inner covering and joins with the opposed outer covering sheet 91, which is glued on to the outer surface of the sides 87 and 88 to form the panel structure in the finished state thereof (see FIG. 20), to thereby delimit a hollow zone therebetween (see FIG. 19), wherein said hollow zone is filled with the afore-mentioned filler material or an insert 92.

Illustrated in FIG. 21 is an eleventh exemplary embodiment of a panel structure according to the present invention, wherein such panel structure is in this case in the form of a box-like cabinet 93 defining three horizontal planes, i.e. flat surfaces 94, 95, 96 extending above each other, and made up by sides joined with each other in the way illustrated in FIGS. 11 and 12.

Finally, a twelfth exemplary embodiment of a panel structure according to the present invention is illustrated in FIG. 22, wherein such structure is in this case shown as being formed of two rectilinear sides 97 and 98 slanting at an angle so as to extend symmetrically relative to each other, and blending into a bottom rectilinear side 99 and top rectilinear side 100 via respective curvatures, wherein the same component parts and the same production techniques are used as described hereinbefore in connection with the other exemplary embodiments discussed.

Further advantages of the panel structures made in accordance with the present invention are:
possibility for one or more panels to be also made of different materials, through the use of materials that may also be selected among the cheapest one available on the market for the intended applications (i.e. chipboard, medium-density fibreboard, honeycomb sandwich board, and the like), which will only or prevailingly require processing at and along the joining regions thereof;
possibility for panels to be also provided with several variously shaped sides to be variously joined to each other, and for appropriate angular stiffening members to be fitted thereinto and/or appropriate channels to be provided therein for use as cableways or similar applications;
possibility for variable-thickness, partially hollow panels to be provided and used, in view of reducing weights and, as a result, production costs;
possibility for panels to be provided with mutually or sequentially joining concave and convex configurations, or even configurations of a different kind, which would be just impossible to be achieved with the use of traditional fabrication or processing methods.

The present invention also covers a method for manufacturing panel structures made in the afore-described manners, such method consisting in that the sides of the panels are joined to each other by not only an outer covering, as applied on to the outward facing surfaces of mutually contiguous panel sides, but also at least an inner covering and/or further sides and/or stiffening members and/or inserts, which are applied on to the inward facing surface of the same sides, thereby delimiting at least a hollow zone between them and the outer covering sheet at the angular joining zones of the sides, wherein such hollow zone is then filled with filler material or inserts, as this has been described hereinbefore, so as to firmly and closely join said sides with each other in a stable manner.

1. Structure of panels made of wooden material for manufacturing furniture, furniture components, furnishing and the like, and products of various kind, wherein such panels or products are provided with one of more side provided with a least an outer covering sheet applied on to the outer part of the same sides, and adapted to decorate and join the sides adjacent to each other, characterized in that said sides are joined to each other also by at least an inner covering (16, 21, 41, 47, 56, 64, 66, 73) and/or by additional sides (9, 10, 31) and/or stiffening elements (23), and/or inserts (74, 90), applied in the inner part of the same sides, and delimiting at the joining angular zones at least an emptied zone among them and said outer covering sheet, which emptied zone is filled with filling materials or inserts, in a way to join and stiffen tightly to each other said sides.

2. Structure of panels according to claim 1, characterized in that said inner covering (41, 47, 56, 64, 66, 73) is applied directly on to the inner part of the relative sides (39, 43, 44, 49, 50, 59, 60, 69, 70).

3. Structure of panels according to claim 1, characterized in that said inner covering (16, 21, 41, 47, 56, 64, 73) is applied on to said additional sides (9, 10, 31) adjacent to each other, in turn applied to the relative panel sides (6, 7, 30).

4. Structure of panels according to claim 1, characterized in that said stiffening elements (23) are shaped in such a way that to be applied directly on the inner side of two adjacent panel sides (19, 20).

5. Structures of panels according to claim 1, characterized in that said inserts (74) are applied between said sides (69, 70) in a position interposed between said outer covering side (72) and inner covering side (73).

6. Structure of panels according to claim 1, characterized in that said inserts (90) perform the function of inner covering and are applied to the inner part of two adjacent panel sides (87, 88).

7. Structure of panel according to claim 1, characterized in that said sides may be also formed by two side half-portions glued to each other in their longitudinal direction, and shaped for defining such emptied zone.

8. Structure of panel according to claim 7, characterized in that said panels may be shaped with different shapes, and joined among them with curved joining zones.

9. Process for manufacturing structures of panels according to claim 1, characterized in that the sides of the panels are joined to each other, besides with said outer covering, also with at least an inner covering (16, 21, 41, 47, 56, 64, 66, 73) and/or with additional sides (9, 10, 31) and/or stiffening elements (23), and/or inserts (74, 90), applied on to the inner part of the same side, and delimiting at the joining angular zones of the sides at least an emptied zone among then and said outer covering sheet, which emptied zone is filled with filling material or inserts, in a way to join and stiffen tightly to each other and said sides.
